(19) United States
(12) Patent Application Publication
(10) Pub. No.: US 2010/0018606 A1
(43) Pub. Date: Jan. 28, 2010

(54) FORMULA DISPENSING UNIT

(75) Inventor: Danny Yacou, New South Wales (AU)

Correspondence Address: SNELL & WILMER LLP (OC), 600 ANTON BOULEVARD, SUITE 1400, COSTA MESA, CA, 92626, US

(73) Assignee: NKOTB Pty Ltd, Wetherill Park, NSW (AU)

(21) Appl. No.: 11/722,418

(22) PCT Filed: Dec. 21, 2005
(86) PCT No.: PCT/AU05/01945

§ 371 Date: Mar. 30, 2009

(30) Foreign Application Priority Data
Dec. 21, 2004 (AU) 2004907255

(51) Int. Cl. B65B 1/04; B01J 19/12

(52) U.S. Cl. 141/311 R; 250/492.1

(57) ABSTRACT

A formula dispensing unit (140) is provided including a container filling station (21), agitating means (110) to promote mixing of the ingredients after they have been placed in the container (120) and control means (138) including a control panel (136) to co-ordinate the operation of the container filling station and the agitating means. The container filling station accepts an empty container (120) and delivers into the container, metered quantities of ingredients to prepare an infant's formula. At a predetermined time the filling operation commences in which a metered amount of the powdered formula is first dispensed into the container followed by a metered amount of water. The control unit then initiates agitation before indicating that the formula is ready.

### CROSS-REFERENCE TO RELATED APPLICATIONS

The present application claims priority from Australian Provisional Patent Application No 2004907255 filed on 21 Dec. 2004, the content of which is incorporated herein by reference.

### INTRODUCTION

The present invention relates generally to the field of food dispensing and in particular, the invention provides an apparatus for the reliable and uniform dispensing of liquid foods such infants' formula.

### BACKGROUND TO THE INVENTION

In the modern world, parents lead busy lifestyles and with often both parents working. This leads to stresses that are exacerbated by having to wake several times a night to feed a young infant. The burden placed on parents who are already tired due to a busy work schedule having to wake in the middle of the night to prepare infants' formula can lead to accidents which could affect the safety of both parent and child. In particular the need to heat the formula may lead to scalding accidents, while improperly heated formula, formula prepared with un-sterilised water or pre-prepared and stored can lead to contamination resulting in the child becoming ill. Incomplete mixing of formula can also lead to problems with teats becoming blocked.

In the event that an infant is not fed immediately after they stir or if a problem such as a blocked teat results in feeding being interrupted, the crying child will inevitably lead to the disturbance of both parents and a deterioration of their composure with resultant further loss of sleep and adverse effects on their ability to perform their daily duties.

In the past, it has been known to provide machines for dispensing hot drinks such as coffee soups etc however these machines are not particularly suited to the preparation of infants' formula.

### SUMMARY OF THE INVENTION

The present invention provides a formula dispensing unit comprising a container filling station which accepts an empty container and delivers into the container, metered quantities of ingredients to prepare an infant's formula and control means to co-ordinate the operation of the container filling station.

The formula dispensing unit preferably also includes an agitating means to promote mixing of the ingredients in the container, and the control means co-ordinates the operation of the agitating means with the operation of the container filling station.

The agitator preferably comprises a vibrating base onto which bottles or other containers maybe located. The base may also include a fastening mechanism or pin which co-operates with a base of a bottle being agitated to prevent the bottle from moving off the base during agitation. A bottle support wall and/or a bottle location plate may also be provided to guide the bottle onto the pressure head. The vibrating base may be actuated to vibrate to provide the agitating motion to the bottle.

When a filled bottle located on the vibrating base, a mixer motor will be actuated to drive the vibrating base to rapidly agitate the bottle in a cyclic motion about the vertical axis. The result of the agitation is to cause fluid motion in the bottle.

The actuation of the agitating unit may be achieved under automatic control of the formula dispensing unit or may be achieved manually. Manual mixing is initiated by placing a bottle on the vibrating base and applying downward pressure on the bottle to actuate a switch in the mechanism that overrides the automatic control and causes the vibrating base to vibrate the bottle and to thereby mix its contents. The manual mixing operation is stopped when the downward pressure is released on the bottle.

The dispensing unit will also preferably include a timer to allow the formula to be scheduled for preparation at regular feeding times, however manual operation is also provided to enable unscheduled feeds to be accommodated.

A water boiling unit is preferably provided to enable sterilisation of water to be performed such that sterilised water is available for use in formula preparation. Water storage is provided to store sterilised water so that it can be available for immediate use when required. The stored water is also preferably kept at or near an optimum serving temperature to avoid delays when the formula is being prepared.

A container sterilising unit is provided to enable clean containers and accessories, such as teats, to be sterilised before use and a storage unit is also preferably provided for sterilised containers in which an ultraviolet light source inhibits development of undesirable organisms such as fungi and bacteria.

Any discussion of documents, acts, materials, devices, articles or the like which has been included in the present specification is solely for the purpose of providing a context for the present invention. It is not to be taken as an admission that any or all of these matters form part of the prior art base or were common general knowledge in the field relevant to the present invention as it existed before the priority date of each claim of this application.

### BRIEF DESCRIPTION OF THE DRAWINGS

Embodiments of the invention will now be described by way of example with reference to the accompanying drawings in which:

FIG. 1 schematically illustrates an embodiment of the present invention which includes a water heating unit, a formula dispensing unit, a container sterilisation unit, a container storage unit and an agitating unit incorporated into a single assembly.

FIGS. 2a & 2b schematically show a) a partial cut open view and b) an exploded view of a water heating unit forming part of the assembly of FIG. 1.

FIGS. 3a & 3b schematically illustrate a) a partial cut open view and b) a partial exploded view of the formula dispensing unit incorporated into the assembly of FIG. 1.

FIGS. 4a & 4b schematically illustrate a) a partial open cut view and b) a partially exploded view of a container sterilising unit incorporated into the assembly of FIG. 1.

FIGS. 5a & 5b schematically illustrate a bottle storage unit respectively in a) a closed and b) an open position;

FIGS. 6a, 6b and 6c schematically illustrate a container agitating unit, showing respectively

a) the location of the unit within the assembly of FIG. 1,
b) an exploded view of the unit with an infants bottle, which is to be mounted on the unit, illustrated in proximity to it; and
c) a view of the unit with the bottle in place;

FIGS. 7(a) to 7(e) schematically illustrate the control functions provided on the control panel 136; and

FIG. 8 illustrates a preferred embodiment of the present invention, which is functionally similar to the unit described with reference to the schematic illustrations of FIGS. 1-7.

### DETAILED DESCRIPTION OF A PREFERRED EMBODIMENT OF THE INVENTION

An embodiment of a formula dispensing unit will now be described in detail with reference to the accompanying drawings.

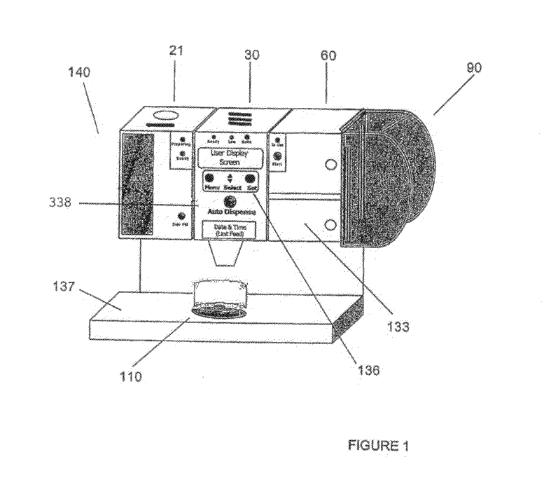

Referring to FIG. 1, a dispensing assembly 140 is illustrated comprising a water heating and storage unit 21, a formula storage and formula dispensing unit 30, a bottle sterilising unit 60 and a bottle and accessory storage unit 90. Further, in the base 137 of the dispensing assembly 140, a bottle agitating unit 110 is provided directly under the formula storage and dispensing unit 30. The bottle agitating unit 110 is used to agitate a bottle receiving a dispensed formula to promote mixing of the dispensed components. The dispensing assembly 140 also includes a control unit 138 including a control panel 136 mounted on the front of the formula storage and formula dispensing unit 30 and an accessory storage unit 133 associated with the sterilising unit 60.

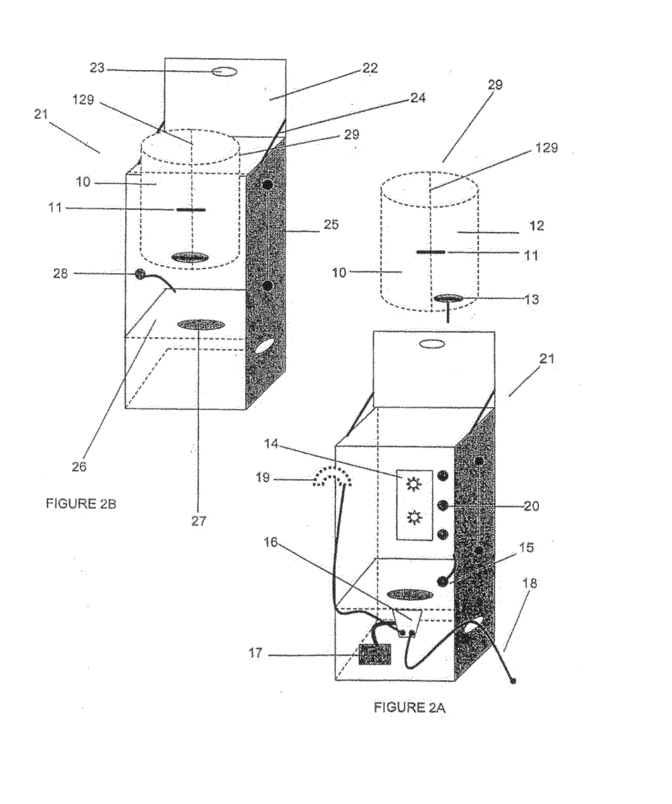

FIGS. 2a and 2b schematically illustrate a water heating and storage unit 21 in greater detail. The water heating and storage unit 21 is used in conjunction with the formula storage and dispensing unit 30 (see FIGS. 3a and 3b) to dispense heated infant's formula into a baby's bottle. The water heating and storage unit comprises an outer housing 121 which includes a lid having an airtight seal and a steam release vent 23, the lid 22 being hinged to the housing 121 and provided with locking arms 24 to maintain the lid 22 in an open position for filling etc. The housing 121 is provided with grooves or slots 25 in the outside of its side walls, shaped to accept connectors which connect the water heating unit to the formula storage and dispensing unit 30, which is fitted with corresponding grooves on its adjacent side (not shown). Within the housing 121, a support platform 6 is located to support a water tank 29, having a boiling compartment 10 and a storage compartment 12. The compartments of the water tank 29 (boiling water compartment 10, and water storage compartment 12), are interconnected by an inter-compartment flow valve 11 allowing recharging of the boiling water compartment. The tank 29 includes a discharge port 13 which cooperates with a discharge port 7 in the support platform 26 and which directs water from the storage compartment 12 into a discharge funnel 16 when dispensing is in progress. Heaters (not shown) are provided in the boiling water compartment 10 to heat water prior to its expected time of use and temperature sensor 28 is provided to monitor temperature of the water in the boiling compartment 10 in order to terminate heating when the water has reached boiling.

Cooling fans 14 are provided in the back of the housing 121 in order to reduce the temperature of water in the water tank after boiling.

A storage temperature sensor 15 is provided to monitor the temperature of water stored for use after having been boiled and cooled, to ensure that the water is at the correct temperature for dispensing into a formula bottle such as a babies formula bottle. Pump 17 is provided to affect discharge of water from the storage tank to either the bottle filling station via the water outlet tube 18 or, alternatively via a side fill outlet 19 which allows ad hoc filling of bottles.

The volume of water dispensed in any dispensing operation is detected by a dispensing volume sensor 20 mounted in the housing 121.

Referring to FIGS. 3a and 3b, the formula storage and formula dispensing unit 30 includes an outer housing 130, a lid 32 hinged to the outer housing 130 and locking braces 33 to hold the lid 32 open for refilling etc. A handle 31 is also provided on lid 32.

Slots or channels 34 are provided in the side of housing 130 to facilitate connection to the adjacent housing and a similar slot or channel is provided in the other side (not shown) for facilitating attachment to the water heating and storage unit 21.

A support platform 35 is provided within the formula storage and formula dispensing unit 30 to support a formula tank 38 which includes a discharge port 41 and a formula level sensor 39. A tank sensor 42 is provided within the housing 130 to detect the presence or absence of the formula tank 38 and to disable operation of the dispensing unit 30 when the tank is not present. Rattlers 43 are also provided to vibrate the tank 38 such that the dry powdered formula in the tank settles to the bottom and does not form a hollow space in the centre after discharge of a certain amount of its contents.

A formula release funnel 44 is located below the support 35 and formula from the tank 38 drops from the discharge port 41 into the release funnel 44 during dispensing. Dispensing is driven by the discharge motor 45 which delivers formula through the formula outlet tube 46 to one side 47 of the dispensing station. The water outlet tube 18 from the water heating and storage unit 21 communicates with the other side 49 of the dispensing outlet, such that the formula and water are dispensed simultaneously into a bottle positioned below.

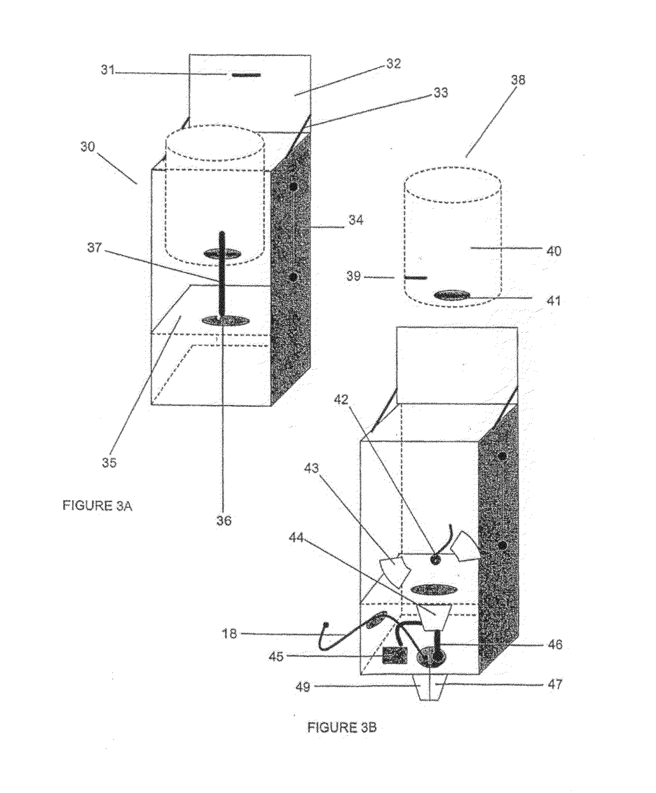

A bottle sterilising unit 60 is illustrated in FIGS. 4a and 4b and comprises an outer housing 160 fitted with a hinged lid 61 and a pair of removable locking arms 63 for holding the lit in the open position whilst stacking bottles into the sterilising unit. The lid 61 is also provided with steam release vent 62.

A sterilising cavity 64 is defined within the housing 160, the bottom of which is formed by a support platform 67 above which a load supporting rack 66 is positioned. Heating elements 68 are provided within the cavity 64 between the support platform 67 and the load supporting rack 66, and a steam vent 69 is provided to dispense steam into the cavity 64 when bottles are being sterilised.

A bottle support spine 70 is removably located in the cavity 64 and rests on the support rack 66, such that bottles may be stacked on the bottle support spine 70, on bottle support ring 72 while teats and other accessories may be located on the accessories steaming tray 71. The spine 70 is supported on a base 73 which sits on the support rack 66 in use.

A front access door 74 is provided on the sterilising chamber 64 and is provided with a thermally non-conductive handle 75.

Below the sterilising chamber cavity 64 is located an accessories storage cavity 81 of a storage housing 80, which is also provided with a front access door 82. The storage cavity 64 is provided with a UV light 83 to limit the growth of harmful bacteria.

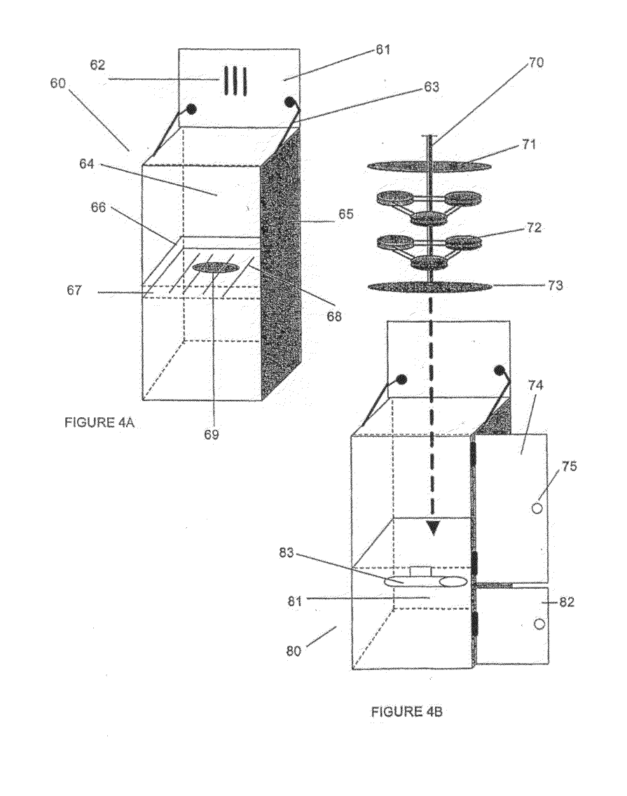

One wall 65 of the bottle sterilising unit 60, forms a common wall with a bottle and accessory storage unit 90 as illustrated in FIGS. 5a and 5b. The bottle and accessory storage unit 90 includes a transparent plastic cover 91 hinged by a cover hinge 92 to the top of the wall 65 of the steriliser housing 160 to define a bottle storage cavity 93. The transparent plastic cover 91 may be lifted using the handle 94 to access bottle support rings 97 on which bottles may be stored. The storage unit is shown in the open position in FIG. 5b. UV lighting 95 is located on the wall 65 of the storage unit to limit bacterial growth in bottles whilst stored in the storage unit.

The bottle support rings 97 are mounted onto bottle ring support racks 96 which enable the support rings 97 to be adjusted in height to accommodate bottles of different sizes.

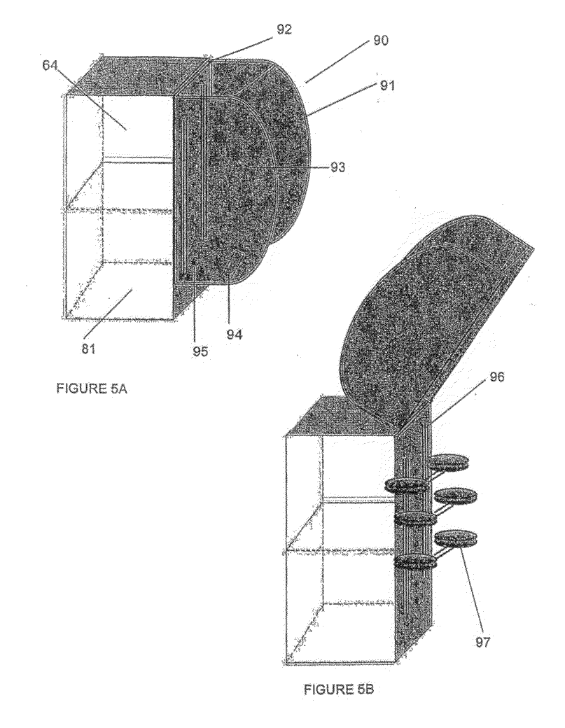

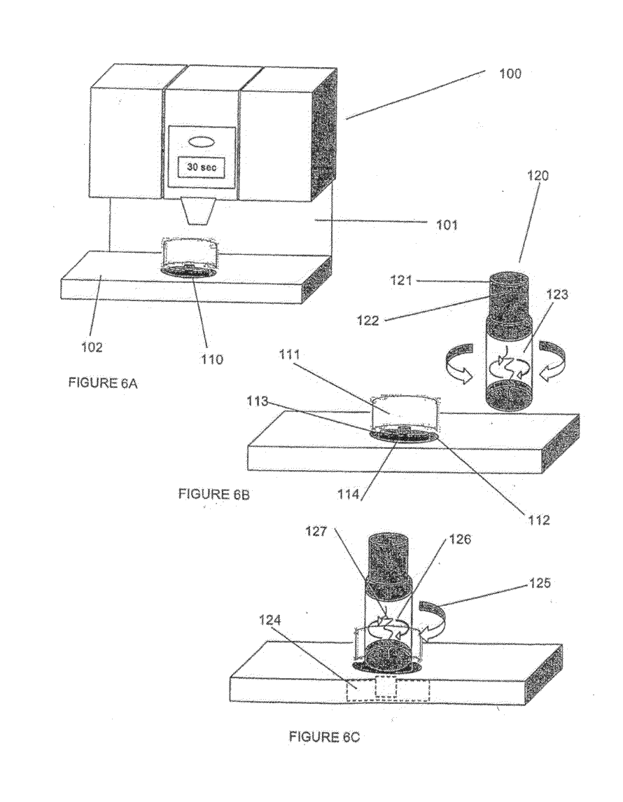

As illustrated in FIG. 6a, a bottle agitator 110 is located in the base 102 of the dispensing assembly 100, with the water heating and storage unit 21, the formula storage and formula dispensing unit 30, the bottle sterilising unit 60 and the bottle and accessory storage unit 90 (not shown in FIG. 6) mounted above the base 102 on a back panel 101.

The agitator 110 comprises a vibrating base 113 onto which bottles or other containers maybe located and includes a fastening mechanism or pin 114 which co-operates with a base of a bottle being agitated to prevent the bottle 120 from moving off the base 113 during agitation. A bottle support wall 111 and a bottle location plate 112 are provided to guide the bottle onto the vibrating base 113 referred to hereafter as a pressure head. The pressure head provides the agitating motion to the bottle. If the bottle has been manually filled, the mixing may be done with the bottle cap 121 and feeding teat 122 already in place. Alternatively, if the bottle is being filled automatically at a predetermined time, for example in anticipation of a babies night feed, a filling funnel 128 may be attached to the top of the bottle, in which case the teat will not be present and formula powder and water will be dispensed through the filling funnel 128 into the bottle cavity 123.

Once the bottle is filled (or even possibly during filling), the mixer motor 124 will drive the pressure head 113 to rapidly agitate the bottle in a cyclic motion 125 about the vertical axis. The result of the agitation is to cause fluid motion 126 in the bottle cavity 123 and a vortex canal 127 will be formed when the fluid within the bottle is moving quickly.

The agitating unit is also capable of manual mixing whereby a bottle is placed on the pressure head 113 and downward pressure is placed on the bottle, causing the pressure head 113 to vibrate the bottle and to thereby mix its contents, the agitation stopping when the downward pressure is released on the bottle.

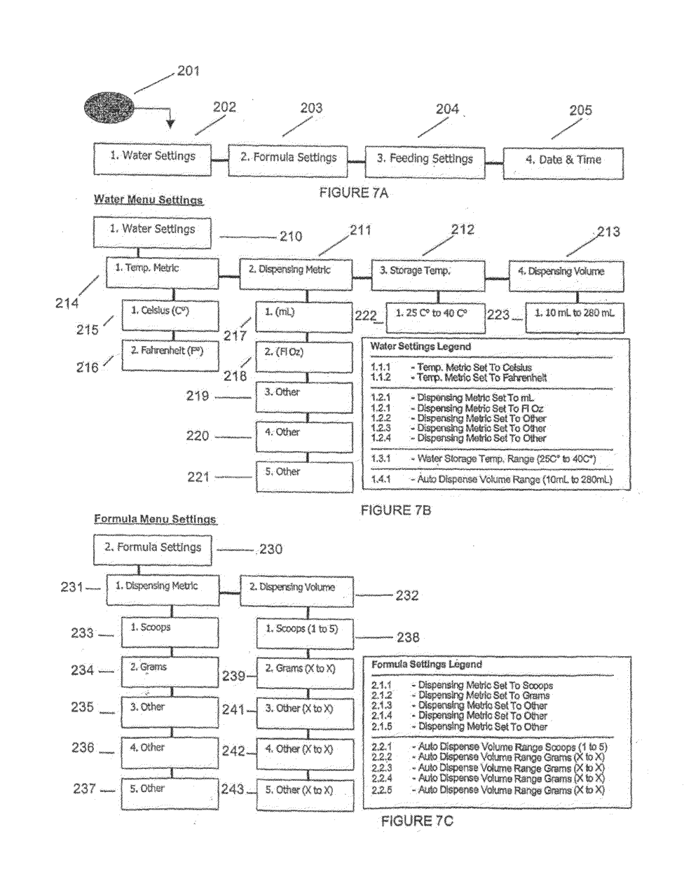

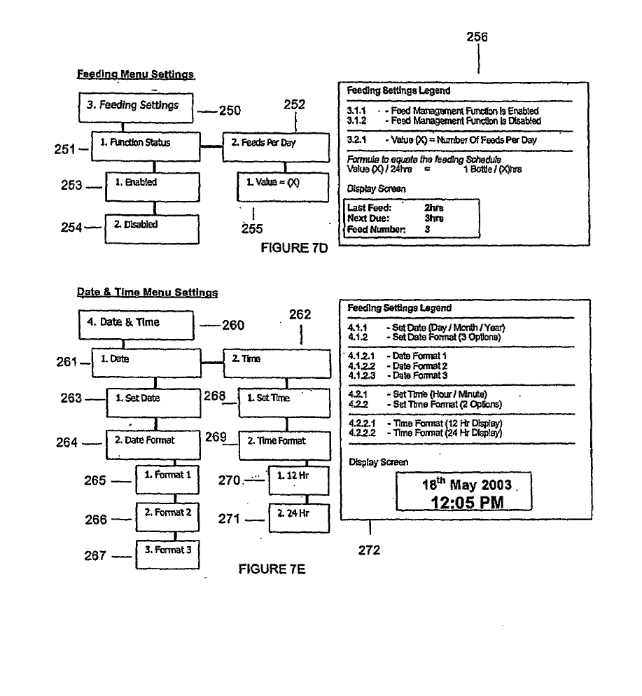

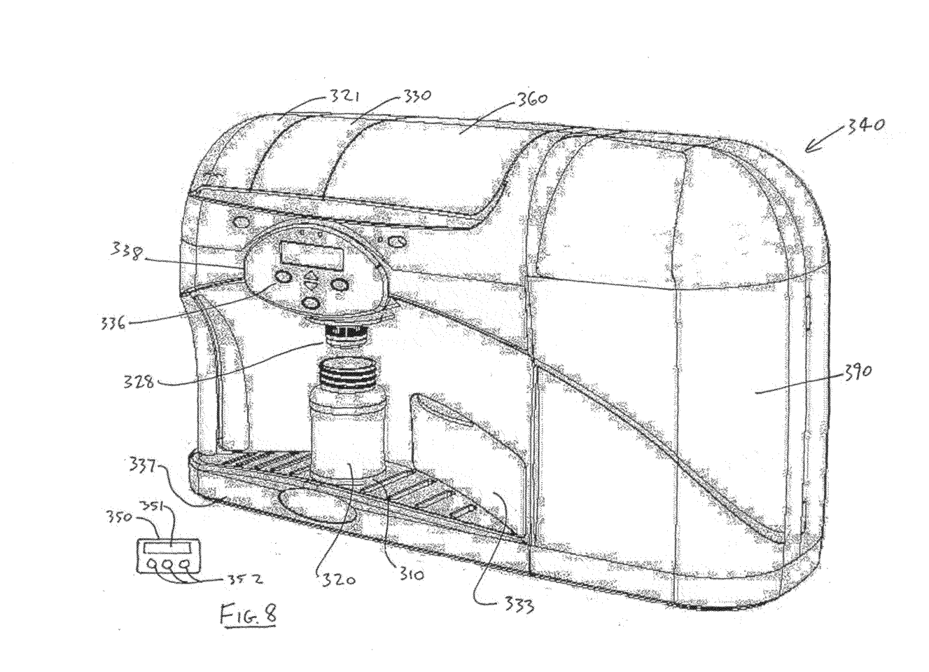

Referring to FIGS. 7(a) to 7(e), the main control functions provided by the control unit 138 (and selected via the control panel 136) are illustrated schematically. The main control menu 201 is illustrated in FIG. 7a and provides access to Water settings 202, Formula Settings 203, Feeding Settings 204, and Date & Time Settings.

Referring to FIG. 7(b), selection of Water Settings 202 in the main menu 201 takes the user to the Water Settings menu 210 allowing selection of the Temperature Metric sub Menu 214, the Dispensing Metric sub menu 211, the Storage Temp., sub menu 212 and the Dispensing Volume sub menu 213. Selection of the Temp., Metric sub menu provides selection between measurements in Celsius 215 and Fahrenheit 216. Selection of the Dispensing Metric sub menu provides selection between measurements in ml 217, Fl oz 218 and other programmable metrics 219, 220, 221. Selection of the Storage Temp., sub menu 212 provides access to a temperature selection function 222 providing selection of temperatures in the range of 25° C. to 40° C. Selection of the Dispensing Volume sub menu 213 provides access to a Dispensing Volume function 223 providing selection of dispensing volumes in the range of 10 ml to 280 ml.

Referring to FIG. 7(c), selection of Formula Settings 203 in the main menu 201 takes the user to the Formula Settings menu 230 allowing selection of the Dispensing Metric sub menu 231 and the Dispensing Volume sub menu 232. The Dispensing Metric sub menu 231 allows selection between dispensing metrics of Scoops 233, Grams 234, and other programmable metrics 235, 236, 237. The Dispensing Volume sub menu 232 allows selection between dispensing volumes of eg 1-5 scoops 238, a range in grams 239 or other programmable ranges 241, 242, 243.

Referring to FIG. 7(d), selection of Feeding Settings 204 in the main menu 201 takes the user to the Feeding Settings menu 250 allowing selection of the Function Status sub menu 251 and the Feeds Per Day sub menu 252. The Function Status sub menu 251 allows Enabling 253 and Disabling 254 of the Feeding control. The Feeds Per Day sub menu 252 allows selection 255 of a value for the number of feeds per day.

Finally, the Date and Time selection 205 in the main menu 201 takes the user to the Date and Time menu 260 allowing selection of the Date sub menu 261 and the Time sub menu 262. The Date sub menu 261 provides a Date Setting function 263 and a Date Format function 264. The Date Format function 264 allows selection of one of a number of common date formats 265, 266, 267. The Time sub menu 262 provides a Time Setting function 268 and a Time Format function 269. The Time Format function 269 allows selection of 12 Hr time 270 or 24 Hr time 271.

Referring to FIG. 8, a preferred embodiment of a dispensing assembly 340 is illustrated comprising a water heating and storage unit 321, a formula storage and formula dispensing unit 330, a bottle sterilising unit 360 and a bottle and accessory storage unit 390. Further, in the base 337 of the dispensing assembly 340, a bottle agitating unit 310 is provided directly under the outlet funnel 328 of the formula storage and dispensing unit 330. The bottle agitating unit 310 is used to agitate a bottle receiving a dispensed formula to promote mixing of the dispensed components. The dispensing assembly 340 also includes a control unit 338 including a control panel 336 mounted on the front of the formula storage and formula dispensing unit 330 and an accessory storage unit 333 associated with the sterilising unit 360.

The agitator 310 comprises a vibrating base onto which bottles or other containers maybe located and which co-operates with a base of a bottle 320 being agitated to prevent the bottle from moving off the base during agitation. The vibrating base may also include a pressure switch which allows manual operation whereby vibration is initiated by pressing down on the bottle while it is placed on the base 313 and stopped by releasing the downward pressure. If the bottle has been manually filled, the mixing may be done with the bottle cap and feeding teat already in place. Alternatively, if the bottle is being filled automatically at a predetermined time, for example in anticipation of a babies night feed, a filling funnel 328 extending from the filling mechanism guides formula and water into the top of the bottle, in which case the teat will not be present and formula powder and water will be dispensed through the filling funnel 128 into the bottle 320.

Once the bottle is filled (or even possibly during filling), a mixer motor (not shown) will drive the agitator 310 to rapidly agitate the bottle in a cyclic motion about the vertical axis as described above.

Also illustrated in FIG. 8 is as pager unit 350 which receives a signal from the dispensing assembly 340 when a bottle has been dispensed and is ready for use. the pager 350 has a display 351 and push buttons 352 which allow control functions to be performed remotely such as delaying the start of the pre-programmed dispensing function or starting the dispensing function before the programmed time.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

1. A formula dispensing unit comprising a container filling station which accepts an empty container and delivers into the container, metered quantities of ingredients to prepare an infant's formula, container agitating means to promote mixing of the ingredients in the container and control means to co-ordinate the operation of the container filling station, and to co-ordinate the operation of the agitating means with the operation of the container filling station.

2. The formula dispensing unit of claim 1 wherein the agitating means comprises a vibrating base onto which the container may be located, whereby the container is agitated by the vibrating base to mix the contents of the container.

3. The formula dispensing unit of claim 2 wherein the vibrating base includes a fastening mechanism which co-operates with a base of a bottle being agitated to prevent the bottle from moving off the base during agitation.

4. The formula dispensing unit of claim 2 wherein the vibrating base includes a locating mechanism which co-operates with a base of a bottle being agitated to prevent the bottle from moving off the base during agitation.

5. The formula dispensing unit of claim 4 wherein the vibrating base includes a pin which co-operates with a base of a bottle being agitated to prevent the bottle from moving off the base during agitation.

6. The formula dispensing unit of claim 4 wherein the vibrating base includes a cup which co-operates with a base of a bottle being agitated to prevent the bottle from moving off the base during agitation.

7. The formula dispensing unit as claimed in claim 4, wherein the vibrating base may be manually actuated to vibrate to provide an agitating motion to the container.

8. The formula dispensing unit of claim 7 wherein manual actuation is achieved by a switch which is actuated by downward pressure on the vibrating base.

9. The formula dispensing unit as claimed in claim 1, wherein actuation of the agitating means is achievable under automatic control of the control unit.

10. The formula dispensing unit as claimed in claim 9, wherein the control unit includes a timer to allow the infant's formula to be scheduled for preparation at predetermined times.

11. The formula dispensing unit as claimed in claim 10, wherein a pager is provided which is responsive to a signal initiated by the controller to indicate to a person located remotely from the formula dispensing unit that the formula dispensed into the container is ready to be consumed.

12. The formula dispensing unit as claimed in claim 1, wherein a location guide is provided to guide the bottle onto the agitating means.

13. The formula dispensing unit as claimed in claim 1, further comprising a water boiling unit to enable preparation of sterilized water for use in formula preparation.

14. The formula dispensing unit as claimed in claim 13, further comprising water storage means to store sterilized water which is subsequently available for immediate use when required.

15. The formula dispensing unit of claim 14, further comprising heating means to keep the water, stored in the storage unit, at or near an optimum serving temperature in the water storage means.

16. The formula dispensing unit as claimed claim 1, further comprising a container sterilizing unit to sterilize containers before use.

17. The formula dispensing unit as claimed in claim 16, further comprising a storage unit for sterilized containers, in which an ultraviolet light source is located to inhibit development of fungi and bacteria.
